(19) United States
(12) Patent Application Publication
(10) Pub. No.: US 2024/0178678 A1
(43) Pub. Date: May 30, 2024

(54) CONTROL OF AN ENERGY STORAGE ARRANGEMENT

(71) Applicants: Martin HUBER, Neu-Ulm (DE); Huber Automotive AG, Muehlhausen i.T. (DE)

(72) Inventors: Martin HUBER, Neu-Ulm (DE); Marcel MAIER, Ulm (DE); Matthias SPAEGELE, Laupheim (DE)

(21) Appl. No.: 18/553,010

(22) PCT Filed: Jun. 28, 2022
(86) PCT No.: PCT/EP2022/067670

§ 371 Date: Sep. 28, 2023

(30) Foreign Application Priority Data
Jun. 30, 2021 (DE) 10 2021 116 884.8
Dec. 14, 2021 (DE) 10 2021 132 889.6
Jan. 25, 2022 (DE) 10 2022 101 711.7

(51) Int. Cl. H02J 7/00; H02J 7/02

(52) U.S. Cl. CPC H02J 7/0019; H02J 7/02

(57) ABSTRACT

An individual cell control of an energy storage arrangement (1) is to be achieved with reduced effort. Thereto, a control device for controlling an energy storage arrangement (1) is proposed, which comprises a plurality of individual cells (2, 2′). In addition, the control device comprises a switching device with individual switching elements (4, 4′) for one or more of the individual cells. The individual switching elements (4, 4′) of the switching device are organized in rows and columns in matrix-like manner. Each of the rows and columns of the switching device is activatable separately from each other such that each of the individual switching elements (4, 4′) can be individually switched on and switched off. A matrix control unit (5) is provided for individually generating a respective activation signal for each individual switching element (4, 4′) of the switching device.

### FIELD

The present invention relates to a control device for controlling an energy storage arrangement, which comprises a plurality of individual cells. Moreover, the present invention relates to an energy storage arrangement with such a control device. Further, the present invention relates to a corresponding method for controlling an energy storage arrangement.

### BACKGROUND

Currently, the above mentioned control devices for controlling energy storage arrangements are mostly a part of a so-called battery management system. Such a battery management system (BMS) usually consists of a battery management controller (BMC) and one or more cell module controllers (CMC). The BMC controls and monitors the CMCs in a subordinated manner and represents the interface to the load (e.g. vehicle). Moreover, the BMS is responsible for the parameters not electronically measurable like the state of charge (SOC) or the residual capacitance (SOH; State of Health). The CMCs control and monitor the individual battery cells and/or battery modules (e.g. also temperature, currents, voltages etc.) and are also responsible for the (usually passive) balancing. The battery modules can consist of multiple individual cells connected in series and/or in parallel.

In order to obtain a sufficient lifetime, the battery cells have to have an identical performance since high balancing currents otherwise flow, which can result in a premature failure of the battery. Moreover, degraded or inefficient battery cells result in a power loss since the weakest cell in a battery module determines the overall power/capacitance of this module.

With present technologies, it is only very expensively possible to individually and selectively switch on or off individual battery cells of an overall battery or of a module. This is a further reason for the installation of exclusively high-performance battery cells. The selection of these battery cells is subject to the so-called packaging method (only batteries with identical performance and identical electrical characteristics are used). This results in high costs and high rejection of battery cells since only the most efficient battery cells can be used.

Accordingly, a disadvantage of the known prior art is in that the individual activation of individual battery cells with conventional BMS systems is very expensive. Thereby, often, the weakest battery cell always determines the capacitance and performance of the battery module or of the overall battery. Possibly, this results in a premature degradation of the individual battery modules or of the entire battery and in a reduction of the lifetime.

Further disadvantages of this known technology are the costs and the effort for the packaging of the battery cells. Furthermore, it is often not possible to switch off defective and degraded cells in a battery module to increase the performance and lifetime of the overall battery.

In addition, the passive balancing across all of the battery cells results in high power losses and high heat development as well as in the degradation of the individual cells. Thus, it is only possible in elaborate systems to individually charge individual cells to e.g. save energy, to ensure fast charging (optimized charging strategy) and to completely charge the still intact and non-degraded cells and to spare the weak cells by switching off on the other hand.

Thus, the object of the present invention is in proposing a control device for an energy storage arrangement, which inexpensively allows an efficient operation. Moreover, a corresponding control method is to be specified.

### SUMMARY

According to the invention, this object is solved by a control device and a method according to the independent claims. Advantageous developments of the invention are apparent from the dependent claims.

Corresponding to the present invention, accordingly, a control device for controlling an energy storage arrangement is provided. The energy storage arrangement can be a battery or an accumulator. Such batteries or accumulators are employed for electrically operated vehicles (electric car, electric bike, electric scooter etc.), solar plants, electric machine tools and the like. The energy storage arrangement comprises a plurality of individual cells. Usually, the individual cells are realized on lithium-ion basis or in another battery technology (e.g. sodium ions) in all conceivable forms (e.g. cylindrical, prismatic, pouch cell). Thereby, individual cells result, which typically provide voltages in the range from 2.4 to 4.2 V (nominally 3.7 V). For vehicles, a plurality of such individual cells is for example connected in parallel and in series in order that an output voltage of more than 400 V and a correspondingly high current for example results for high-voltage systems.

The control device comprises a switching device with individual switching elements for one or more of the individual cells. Accordingly, the control device is based on a smart individual cell activation. This means that it is possible by means of the present invention to individually and separately activate individual cells of a battery module or of the overall battery. I.e., each battery cell of an overall battery can thereby be individually switched on and/or off.

As was indicated above, it is also possible that the individual cells are interconnected in parallel and in series, respectively, in groups to form modules. Such modules can in turn be individually activated and are in turn optionally connected in parallel or in series with each other to the overall battery or to the energy storage arrangement.

The smart individual cell activation allows eliminating the disadvantages of the known battery management systems and e.g. to switch on or switch off individual cells in charging and discharging, respectively, the energy storage arrangement.

The individual switching elements of the switching device are organized in rows and columns in a matrix-like manner. This does not necessarily mean that the individual switching elements also have to be arranged corresponding to the matrix. Rather, the individual switching elements are logically connected to each other in particular in the form of a two-dimensional matrix. Therein, an individual switch can switch an individual cell or else a module of multiple individual cells. Since the individual switching elements are organized in rows and columns, each individual switching element can be individually addressed or controlled via the rows and columns.

Thus, especially, each of the rows and columns of the switching device is activatable separately from each other such that each of the individual switching elements can be individually switched on and switched off. Thus, the rows can for example be raised to a special voltage level independently of each other. The same applies to the columns. In particular, the rows are also activatable independently of the columns. Due to the activation of the rows and the columns, a respectively separate activation of the individual switching elements is not needed. Rather, all of the individual switching elements of a row and all of the individual switching elements of a column can each be commonly activated. In this manner, the activation effort can be correspondingly reduced. Especially, the activation effort can be reduced to twice the root square with respect to the number of the activation elements.

Moreover, the control device comprises a matrix control unit for individually generating a respective activation signal for each individual switching element of the switching device. Especially, an individual activation signal is composed of a row signal and a column signal. Both partial signals are transferred via the respective row and column, respectively, of the switching device. Thereto, the matrix control unit is capable of feeding the respective partial signal into the respectively required row and required column and thus to correspondingly activate the cell switches.

Thus, according to the invention, individual or multiple electronic switches can be provided, which are located at each battery cell. These electronic switches are activated via a smart matrix circuit. The battery cells are, for example, activated and supervised via a row and column decoder (e.g. demultiplexer). The realization can be effected e.g. via ASICs, FPGA, μC etc. The general functional principle is based on a technology known in the digital technique (e.g. storage cell activation).

It is provided that the matrix control unit comprises a single column control element and a separate row control element for each column. The column control element and the row control element can for example be the mentioned demultiplexer, ASIC, FPGA etc. Thus, all of the columns of the matrix are activated by the column control element. In contrast, only the rows of a single column are activated by each row control element. For example, such a structure is advantageous if individual modules are addressed via the columns and the individual cells in the modules are addressed via the rows. This means that each module is individually activatable via the column control element and each individual cell in the various modules is activatable via the row control element. In an alternative embodiment, it can also be provided that the different switches, whether module switches or individual cell switches, are coordinately treated. This means that a coordinate in the two-dimensional matrix system is simply associated with each of these switches. In this case, it is sufficient, if a single column control element and a single row control element are provided. The designations “column” and “row” can also be used interchanged with each other in the present document.

Corresponding to a special embodiment, each activation signal is a pulse and each switch-on element is formed to further hold the switching state induced by the pulse at least for a predetermined time also after the respective pulse. Therein, the pulse is e.g. a part of a sequential programming pulse, which is executed at least twice, to address all of the row and column control elements (switch-on elements). Such a holding of the switching state also after the pulse is usually required since the individual cells are to further output energy also after the respective switch-on for example for discharging the energy storage arrangement. The same applies to switch-off of an individual cell. By a switch-off pulse, the respective cell is to be disconnected from the composition and usually also further remain disconnected from the composition. Thus, the switching state is to be further held for a predetermined time after the pulse. For example, the switching state is held until a new pulse (e.g. fixed cycle) arrives at the individual switching element. Optionally, the switching state is held for a period of time after the pulse, which corresponds to a multiple of the pulse duration.

In an alternative embodiment, it is provided that switching elements of the matrix (not the individual switching elements) are capable of holding a switching state. In this case too, an activation signal can be a pulse. At each node point of the rows and columns of the matrix control unit, a matrix switching element is arranged, wherein each matrix switching element is formed to further hold the switching state induced by the pulse at least for a predetermined time also after the respective pulse. Thus, in this case, a control line is respectively passed from each node point of the matrix to an individual switching element. Here, the individual switching element does not have to have the capability of storing or maintaining the switching state. Rather, the switching state of the individual switching element immediately changes with the voltage level at the output of the respective matrix switching element. In this type of matrix control unit, the entire activation (column-row decoder and matrix switching element) could be realized in a CHIP (ASIC, FPGA), which comprises sufficient “storage cells”.

In a special embodiment, it is provided that each individual switching element or each matrix switching element comprises a bistable relay, a bistable flip-flop, a floating gate transistor or a thyristor. All of these switching elements can have the capability of holding a switching state over longer time or in permanent manner. For example, a bistable relay maintains the switching position after disconnection of the exciter circuit, which was present after the last excitation. The same applies to bistable flip-flops. A flip-flop, i.e. a bistable multivibrator, is an electronic circuit, which has two stable states of the output signal. Therein, the current state is dependent not only on the currently present input signals, but additionally on the state, which existed before the considered point of time.

A floating gate transistor is a special transistor, which is employed in non-volatile memories for permanent information storage. In a programming operation, the transistor stores energy on the so-called “floating gate”, whereby the transistor is either drivable or not drivable. Hereby, the individual switching elements of the cells can be correspondingly activated. Herein, a one-time/sequential programming pulse (e.g. once column, once row, overall at least two operations) can be introduced and the floating gate transistor stores this information and thus is ON/OFF. If it is then the cell switch at the same time, this would be particularly advantageous. If this type of the transistor technology should not function for such applications. Alternatively, they could act as control switches for FETs (cell switch) with very low Rdson (e.g. <5 mOhms).

The thyristor is a member capable of being switched on, i.e. it is not conducting in the initial state and can be switched on by a small current on the gate electrode. After switching on, the thyristor remains conducting also without gate current. It is switched off by falling below a minimum current, namely the holding current.

According to a further embodiment, the matrix control unit—as mentioned above—comprises an FPGA, μC (microcontroller), an ASIC or a demultiplexer as the column control element and/or row control element. The two control elements can be accommodated in one and the same chip. The column control element and the row control element can also be referred to as column decoder and row decoder, respectively. It is achieved by them that one or more signals of a microprocessor are for example distributed to the multiple columns and multiple rows, respectively. Therein, each column and each row, respectively, can be individually activatable via the column control element and row control element, respectively.

According to the invention, an energy storage arrangement with a plurality of individual cells each for storing energy and a control device of the above mentioned type is also provided. Therein, each of the individual cells can be individually switched on and switched off by one of the individual switching elements. As was already mentioned, the energy storage arrangement can be used as an energy storage for a vehicle, a solar plant, an electric tool and much else. In any case, it comprises a plurality of individual cells interconnected in parallel and/or in series, which are individually activatable with low effort by the control device due to the matrix organization.

In a preferred configuration, the energy storage arrangement comprises a power output, at which the individual cells are switchable by the control device, wherein the control device is formed to generate an AC voltage, in particular with sinusoidal progression, at the power output. Usually, a DC voltage is applied to the power output of an energy storage arrangement with individual cells. An AC voltage can be generated from this DC voltage by an inverter. However, the inverter can be realized in that the individual cells of the energy storage arrangement are cyclically interconnected to each other. In this manner, the voltage at the power output can for example increase in that more and more additional cells are connected in series. In sequentially switching off the individual cells, the voltage at the power output can correspondingly again decrease. If an additional pole reversal is provided, thus, negative voltages can also be generated in this manner. Especially, a sinusoidal progression of the output voltage can thus also be realized. However, it is to be noted therein that the sinusoidal shape can usually only be achieved by corresponding voltage steps, wherein each individual step of the voltage corresponds to an individual cell. In a specific case, individual voltage steps can be switched on and off such that a virtually sinusoidal progression of the voltage amplitude can be generated at the power output (AC voltage). The negative amplitude can be generated via a corresponding electronic circuit, in particular H bridges. Alternatively, a direct current motor (e.g. BLDC, brushless direct current motor) would also be conceivable as a load. By the matrix arrangement, a very variable/continuously adjustable “direct current” power could be adjusted by fast switching on and off the cells, whereby the torque of a DC motor would also be continuously variable and one could optionally save expensive converters etc. thereby.

In a further embodiment, the energy storage arrangement can comprise a power input, at which the individual cells are individually switchable for charging by the control device. By the matrix circuit, individual cells can be individually activated with low effort, to be able to then separately charge them. In addition, it can also be directly charged with AC voltage by switching on and off the cell switches, respectively (row/series connection). In a special configuration, individual voltage levels could be switched on and off in charging by the matrix circuit, whereby charging at an AC voltage source becomes possible corresponding to the sinusoidal voltage progression of the source.

According to the invention, the object formulated above can also be solved by a method for controlling an energy storage arrangement, which comprises a plurality of individual cells, by switching the individual cells with respective individual switching elements, wherein the individual switching elements are organized in rows and columns in a matrix, and wherein each of the rows and columns of the matrix is activated separately from each other, such that each of the individual switching elements can be individually switched on and switched off, and individually generating a respective activation signal for each individual switching element of the switching device for switching on and switching off by means of a matrix control unit.

The advantages and possibilities of variation mentioned in context of the control device and energy storage arrangement according to the invention, respectively, analogously apply to the method according to the invention. Therein, the corresponding functional features are to be regarded as respective method steps.

### BRIEF DESCRIPTION OF THE FIGURES

Now, the present invention is explained in more detail based on the attached drawings.

FIG. 1 depicts an exemplary battery topology with battery management system.

FIG. 2 depicts a matrix circuit for activating individual cells of a battery storage arrangement.

FIG. 3 depicts an alternative matrix circuit for activating individual cells of a battery storage arrangement.

FIG. 4 depicts a floating gate transistor in sectional representation.

FIG. 5 depicts a further embodiment of a matrix switching element.

The embodiments described below represent preferred embodiments of the present invention.

### DETAILED DESCRIPTION

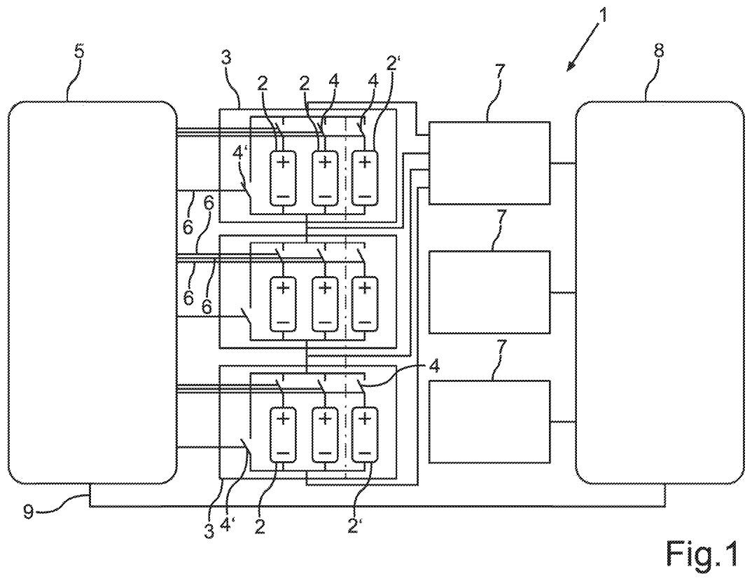

In FIG. 1, the topology of a battery storage device, e.g. of a battery storage, is exemplarily illustrated. FIG. 1 shows an energy storage arrangement 1 with a plurality of individual cells 2, 2′. While the individual cells 2 represent standard utilization cells, the individual cells 2′ are replacement cells. However, it is not required that an energy storage arrangement comprises such replacement cells 2′. The number of individual cells as well as the arrangement and connections thereof can also be arbitrarily selected.

In the present example, three of the individual cells 2, 2′ are each interconnected to a module 3. Especially, the individual cells 2, 2′ are connected in parallel within a module 3. An individual switching element 4 is respectively in series with each individual cell 2, 2′. If the individual switching elements 4 in series with the individual cells 2, 2′ are closed, thus, the individual cells 2, 2′ are connected in parallel with each other. Of course, it would also be conceivable that the module is composed of cells connected in series and they are arranged in parallel with further modules.

Here, each module 3 additionally comprises a further individual switching element 4′, which can be employed for bypassing the respective module 3. This bypass switch 4′ is in parallel with the parallel connection of the individual cells 2, 2′ with their cell switches or individual switching elements 4. Thus, while the individual cells are individually switchable by the cell switches 4, the individual modules 3 are switchable by the bypass switches 4′.

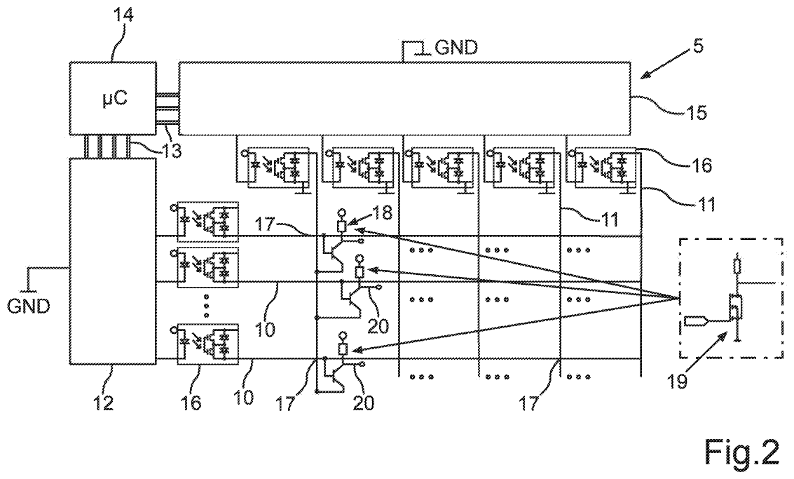

Here, all of the individual switching elements 4, 4′, i.e. all of the cell switches 4 and all of the module switches 4′, are electrically controllable. Thereto, each individual switching element 4, 4′ is connected to an activation logic 5 via respective control lines 6. The activation logic 5 is explained in more detail based on an exemplary schematic block diagram in FIG. 2.

Here, the voltages of the individual modules 3 are tapped by a cell module controller 7 (CMC). For further modules 3, further cell module controllers 7 can be provided. A battery management controller 8 (BMC) is superordinated over the cell module controllers 7. This battery management controller 8 controls and monitors the cell module controllers 7 and thus represents the interface to the load (e.g. vehicle). In addition, the battery management controller 8 comprises a communication interface 9, via which information can be exchanged with the activation logic 5 (alternatively, the activation logic can be integrated in the CMC). Thus, the battery management controller 8 can communicate switching commands to the activation logic 5, and the activation logic 5 can provide state data about the individual switching elements 4, 4′ to the battery management controller 8 on the other hand.

The control of the individual cells 2 of the energy storage arrangement 1 by means of the cell module controllers 7 and the battery management controller 8 as well as the division of the individual cells into modules 3 is to be regarded as purely optional.

FIG. 2 reproduces a matrix circuit, which can be employed for a control device according to the invention. In other words, the illustrated matrix circuit can be used as an activation logic 5 for the individual cells 2, 2′ and the modules 3, respectively. The matrix circuit is based on a two-dimensional matrix with rows and columns. Accordingly, the matrix circuit comprises row control lines 10 and column control lines 11. The row control lines 10 are fed by a row decoder 12. The row decoder 12 preferably comprises a ground connection GND. For example, the row decoder 12 is formed as an FPGA, ASIC or demultiplexer. With the aid of selection lines 13, it can be connected to a microprocessor 14. The selection lines 13 preferably serve for the binary signal transfer. With the aid of four selection lines 13, thus, 16 rows can for example be selected. If a serial bit stream is alternatively clocked into a shift register, thus, any number of outputs can be controlled.

In the same manner, the column control lines 11 are supplied by a column decoder 15. It is also activated by the microprocessor 14 via selection lines 13. Here, three selection lines 13 are exemplarily provided, such that eight columns are activatable in case of binary control. Of course, the number of the rows and columns is arbitrarily selectable.

Optionally, the row control lines 10 are supplied by the row decoder 12 via optocouplers 16. These optocouplers 16 ensure a galvanic separation of the row control lines 10 and the row decoder 12. In the same manner, the column control lines 11 can also be connected to the column decoder 15 via optocouplers 16 such that different voltage levels of the rows/columns are reliably switchable. Hereby, the LV range can in particular be properly separated from the HV range.

A matrix switching element 18 or a cell switching element is arranged at each node point 17 of the matrix, i.e. at each intersection of a row control line 10 and a column control line 11. Theren, an electrode of the matrix switching element 18 is connected to the respective column control line 11 and another electrode of the matrix switching element 18 is connected to the respective row control line 10. In FIG. 2, the matrix switching element 18 is indicated by a transistor symbol. For example, the control electrode (base or gate) is connected to the respective row control line 10 and an electrode of the power path (e.g. emitter or drain) is connected to the respective column control line 11. Preferably, the matrix switching element 18 is formed with a MOSFET 19. The matrix switching element 18 comprises each one output terminal 20 at the second electrode of the power path. This output terminal is connected to the respective control line 6 of the activation logic 5 (compare FIG. 1). Thus, a respective individual switching element 4, 4′ is directly activatable by a matrix switching element 18.

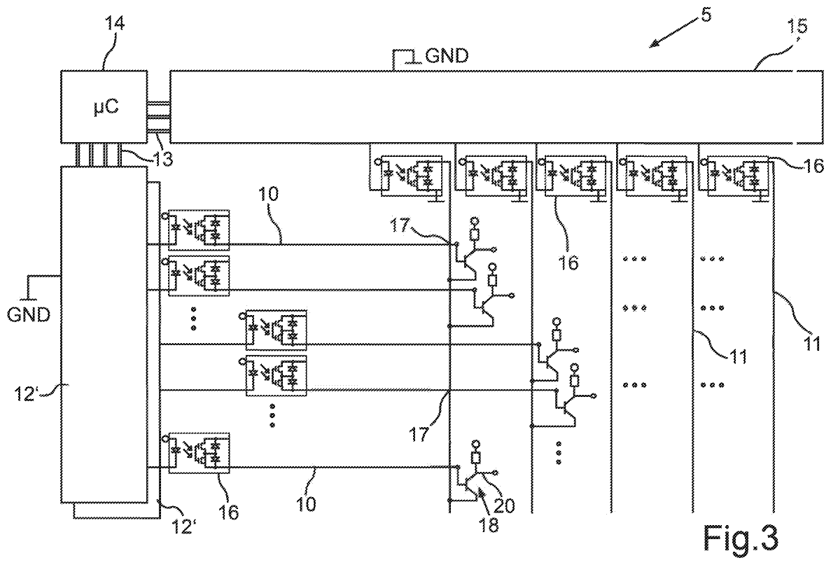

An alternative activation logic 5 in the form of a matrix circuit is reproduced in FIG. 3. The matrix circuit substantially corresponds to that of FIG. 2. Therefore, the above description to FIG. 2 also applies here with the following exceptions: instead of a single row decoder 12, here, multiple row decoders 12′ are used. Each row decoder 12′ activates the respective matrix switching elements 18 and rows of a single column of the matrix, respectively. Thus, the matrix switching elements 18 and rows of the first column in FIG. 3, respectively, are activated by the row decoder 12′ illustrated above. The matrix switching elements 18 and rows of the second column in FIG. 3, respectively, are activated by the row decoder 12′ illustrated below, and so on. Each column of the matrix can for example serve for activating one of multiple modules of the energy storage arrangement. A module-specific row decoder 12′ can then be used for activating individual switching elements 4, 4′ at the individual cells 2, 2′. However, the columns do not have to be associated with fixed modules. Other groupings and associations, respectively, of the columns and rows with the switching elements can also be made.

For the operation of the energy storage arrangement, it is the usual case that most of the individual cells are switched on during the operation. Only in the exceptional case, one or a few of the individual cells are switched off during the operation and optionally replaced with a replacement cell. For the cell switches, i.e. the individual switching elements 4 of the switching device, this means that they are predominantly switched on during the operation. Thus, if usual transistors are for example used for the individual switching elements, which only turn on upon activation, thus, these transistors have to be virtually permanently activated for the described purpose of employment. This could not be readily realized by a matrix if an individual cell is to be switched off by it and all of the other ones remain on. Basically, it is of course possible to cyclically activate the individual cells, wherein usual transistors can be used as the switching elements. In this manner, a pulsed direct current can for example be established by this matrix control, wherein the individual cells or groups of individual cells are cyclically sequentially switched on and switched off, respectively. In similar manner, an alternating current or an AC voltage can for example also be generated by such usual transistors and the matrix circuit in that the switches are switched via the matrix circuit such that a corresponding AC voltage results due to the interconnection of the individual cells.

However, if, as usual in a vehicle, the operating voltage is to be held high as a DC voltage, wherein a major part of the individual cells is switched on, thus, it is required to equip the individual switching elements 4, 4′ or the matrix switching elements 18 of the activation logic 5 with a type of storage function. In particular, then, they should maintain the switching state over a longer time, even if the activation, for example by means of a pulse, is already terminated.

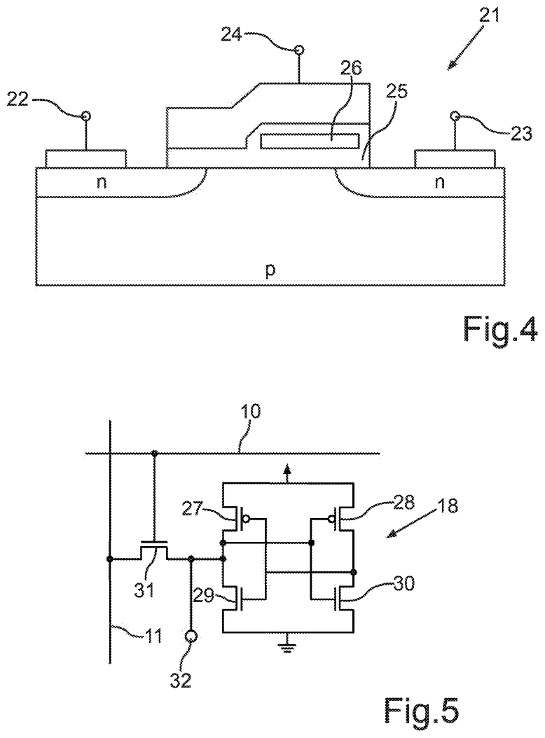

For example. a floating gate transistor, which is illustrated in FIG. 4, could serve as such a switching element with storage capability. The floating gate transistor 21 for example comprises a p-doped substrate as well as each one n-region for source 22 and drain 23. A control electrode or a gate 24 is between drain and source as in a usual MOSFET transistor and connects the n-regions thereof. Therein, the gate 24 is insulated from the p-doped substrate by an oxide layer 25. A floating gate 26 is embedded in the insulating oxide layer 25. Positive charge is stored in this floating gate 26 in programming. By these positive charges, a permanent, conducting channel arises between the n-regions of source 22 and drain 23. This conducting channel remains at least as long as the charge remains stored in the floating gate 26. Thereby, a corresponding storage effect results and the switching state of the floating gate transistor can be adjusted by respective programming.

In an alternative embodiment, the electrical circuit illustrated in FIG. 5 can be used for the matrix switching element 18. Here, the electrical circuit comprises two P-FET (field effect transistors) 27, 28 and three N-FET 29, 30, 31. A first terminal of the drain-source channel of the first P-FET 27 is connected to a first terminal of the drain-source channel of the second P-FET 28 and connected to a supply voltage. A second terminal of the drain-source channel of the first P-FET 27 is connected to a first terminal of the drain-source channel of the first N-FET 29. A second terminal of the drain-source channel of the second P-FET 28 is connected to a first terminal of the drain-source channel of the second N-FET 30. A second terminal of the drain-source channel of the first N-FET 29 is connected to a second terminal of the drain-source channel of the second N-FET 30 and grounded. The gates of the first P-FET 27 and of the first N-FET 29 are connected to each other and connected to the first terminal of the drain-source channel of the second N-FET 30. The control electrodes of the second P-FET 28 and of the second N-FET 30 are connected to each other and connected to the second terminal of the drain-source channel of the first P-FET 27.

A third N-FET 31 is connected to the column control line 11 at a terminal of the drain-source channel and connected to the second terminal of the drain-source channel of the first P-FET 27 by the other terminal of the drain-source channel. This terminal represents an output 32, to which a cell switch or an individual switching element 4, 4′ is connected. The control electrode of the third N-FET 31 is connected to the row control line 10. This circuit holds the respective state at the output 32 until it is reprogrammed via the third N-FET 31 and the two control lines 10, 11, respectively. This circuit can also be realized by other members functioning in analogous manner.

However, the matrix switches with storage function can also for example be realized by bistable relays or bistable flip-flops. If these switching elements with storage functionality are used for the cell switches, they are to be correspondingly low-ohmic.

By the control device exemplarily illustrated above for controlling an energy storage arrangement, numerous advantages can be gained. On the one hand, specific switching on and/or off of individual battery cells and/or of individual battery modules is possible. Similarly, a specific, smart and individual balancing of the individual battery cells, i.e. individual cells, is possible. Moreover, a new type of the balancing including novel charging strategy for the overall battery is allowed. Thus, the thermal losses and the energy consumption are greatly reduced. In addition, a gentle and complete charging, respectively, of all of the battery cells can be achieved. The overall battery capacitance and the lifetime can also be increased. In addition, the degraded or defective cells can be switched off. In addition, replacement cells can be switched on to supersede defective and/or degraded cells.

Furthermore, an increase of the overall battery safety by the immediate switch-off of all of the cells in the state of danger results. In addition, there is no danger caused by high voltages due to the possibility of the individual cell switch-off. By the possibility of the novel individual cell activation, packaging for battery cells is no longer mandatory. Battery cells with different capacitance (also not high-performance battery cells) can be used since the smart activation automatically takes over the packaging within the overall battery. This results in a great cost reduction of the overall battery and of the production process. Finally, the direct activation of all of the individual battery cells is now also possible such that AC voltage signals (of any form) can be directly generated and output for example without a classical converter. Thereby, it is possible to directly operate also alternating current loads besides direct current loads.

1. A control device for controlling an energy storage arrangement, which comprises a plurality of individual cells, the control device comprising:
a switching device with individual switching elements for one or more of the plurality of individual cells of the energy storage arrangement,
wherein the individual switching elements of the switching device are organized in rows and columns in matrix-like manner, and
wherein each of the rows of the switching device is activatable by a respective row signal and each of the columns of the switching device is activatable by a respective column signal, separately from each other, such that each of the individual switching elements can be individually switched on and switched off; and
a matrix control unit configured to individually generate a respective activation signal for each individual switching element of the switching device, wherein the matrix control unit comprises a single column control element and a separate row control element for each column.

2. (canceled)

3. The control device according to claim 1, wherein each control signal is a pulse and each individual switching element is formed to further hold a switching state induced by the pulse at least for a predetermined time after the respective pulse.

4. The control device according to claim 1, wherein each activation signal is a pulse, a matrix switching element is arranged at each node point of the rows and columns of the matrix control unit, and each matrix switching element is formed to further hold a switching state induced by the pulse at least for a predetermined time after the respective pulse.

5. The control device according to claim 3, wherein each individual switching element or each matrix switching element comprises a bistable relay, a bistable flip-flop, a floating gate transistor or a thyristor.

6. The control device according to claim 1, wherein the matrix control unit comprises an FPGA, an ASIC or a demultiplexer as the column control element and/or as the row control element.

7. An energy storage arrangement comprising:
a plurality of individual cells respectively for storing energy; and
a control device according to claim 1, wherein
each of the individual cells can be individually switched on and switched off by one of the individual switching elements.

8. The energy storage arrangement according to claim 7, comprising a power output, to which the individual cells are switchable by the control device, wherein the control device is formed to generate an AC voltage in particular with sinusoidal progression at the power output.

9. The energy storage arrangement according to claim 7, comprising a power input, to which the individual cells can be individually switched for charging by the control device.

10. A method for controlling an energy storage arrangement, which comprises a plurality of individual cells, the method comprising:
switching the plurality of individual cells by individual switching elements
wherein the individual switching elements are organized in rows and columns in a matrix, and
wherein each of the rows of the matrix is activated by a respective row signal and each of the columns of the matrix is activated by a respective column signal, separately from each other, such that each of the individual switching elements can be individually switched on and switched off; and
individually generating a respective activation signal from the corresponding row signal and the corresponding column signal for each individual switching element of the switching device for switching on and switching off by means of a matrix control unit,
wherein the matrix control unit comprises a single column control element and a separate row control element for each column.

11. The control device according to claim 4, wherein each individual switching element or each matrix switching element comprises a bistable relay, a bistable flip-flop, a floating gate transistor or a thyristor.

12. The energy storage arrangement according to claim 8, comprising a power input, to which the individual cells can be individually switched for charging by the control device.

13. A control device for controlling an energy storage arrangement, which comprises a plurality of individual cells, the control device comprising:
a switching device with individual switching elements for one or more of the plurality of individual cells of the energy storage arrangement,
wherein the individual switching elements of the switching device are organized in rows and columns in matrix-like manner, and
wherein each of the rows of the switching device is activatable by a respective row signal and each of the columns of the switching device is activatable by a respective column signal, separately from each other, such that each of the individual switching elements can be individually switched on and switched off; and
a matrix control unit configured to individually generate a respective activation signal from the corresponding row signal and corresponding column signal for each individual switching element of the switching device.

14. The control device according to claim 13, wherein the matrix control unit comprises a single column control element and a separate row control element for each column.

15. The control device according to claim 13, wherein each control signal is a pulse and each individual switching element is formed to further hold a switching state induced by the pulse at least for a predetermined time after the respective pulse.

16. The control device according to claim 13, wherein each activation signal is a pulse, a matrix switching element is arranged at each node point of the rows and columns of the matrix control unit, and each matrix switching element is formed to further hold the switching state induced by the pulse at least for a predetermined time also after the respective pulse.

17. The control device according to claim 15, wherein each individual switching element or each matrix switching element comprises a bistable relay, a bistable flip-flop, a floating gate transistor or a thyristor.

18. An energy storage arrangement comprising
a plurality of individual cells respectively for storing energy, and
a control device according to claim 13, wherein
each of the individual cells can be individually switched on and switched off by one of the individual switching elements.

19. The energy storage arrangement according to claim 18, comprising a power output, to which the individual cells are switchable by the control device, wherein the control device is formed to generate an AC voltage in particular with sinusoidal progression at the power output.

20. The energy storage arrangement according to claim 18, comprising a power input, to which the individual cells can be individually switched for charging by the control device.

21. A method for controlling an energy storage arrangement, which comprises a plurality of individual cells, the method comprising:
switching the individual cells by individual switching elements, wherein
the individual switching elements are organized in rows and columns in a matrix, and wherein
each of the rows of the matrix is activated by a respective row signal and each of the columns of the matrix is activated by a respective column signal separately from each other such that each of the individual switching elements can be individually switched on and switched off, and
individually generating a respective activation signal from the corresponding row signal and the corresponding column signal for each individual switching element of the switching device for switching on and switching off by means of a matrix control unit.
